(19) United States
(12) Patent Application Publication
(10) Pub. No.: US 2007/0282492 A1
(43) Pub. Date: Dec. 6, 2007

(54) METHOD AND SYSTEM OF MANAGING DATA TRANSMISSIONS FROM BROADCAST-EQUIPPED TARGETS

(75) Inventors: Edward M. Valovage, Memphis, NY (US); Jeffrey Legge, Syracuse, NY (US); Kenneth B. Samuelson, Fayetteville, NY (US)

Correspondence Address: BURR & BROWN, PO BOX 7068, SYRACUSE, NY, 13261-7068, US

(73) Assignee: Sensis Corporation, East Syracuse, NY (US)

(21) Appl. No.: 11/751,098

(22) Filed: May 21, 2007

Related U.S. Application Data
(60) Provisional application No. 60/809,590, filed on May 31, 2006.

(51) Int. Cl. G06F 17/00

(52) U.S. Cl. 701/3

(57) ABSTRACT

A method of and system for managing data transmissions from a plurality of targets (e.g., aircraft), each of which is equipped with an on-board broadcast system that transmits data within an established time frame. The method includes the steps of defining at least a first geographic region and a second geographic region, for each geographic region, dividing the established time frame into a contiguous set of time slots, defining a time slot sequence order by which each target within each geographic region will transmit data within said established time frame, and instructing each aircraft located within the first geographic region to transmit its data at a specific index point or offset within the time slot sequence order for the first geographic region and each aircraft located within the second geographic region to transmit its data at a specific index point or offset within the time slot sequence order for the second geographic region.

### FIELD OF THE INVENTION

The present invention relates to a method and system for managing data transmissions from a plurality of broadcast-equipped targets, and in particular relates to a method and system of managing data transmissions from a plurality of ADS-B-equipped aircraft.

### BACKGROUND OF THE INVETION

Datalink systems are used by air traffic management systems as the primary means of communication with and between aircraft. Each datalink is assigned a specific frequency bandwidth. Aircraft datalink systems use various media access allocation schemes. The term “media access” refers to the method by which a user, such as an aircraft or ground station, accesses the assigned frequency bandwidth of the communications system.

Datalink communications to and from aircraft are unique compared to other types of communications systems, because of the signal transmission propagation times that are involved (i.e., due to the distances between the transmitter and receiver) and the speeds at which the aircraft operate. The signal propagation time for aircraft datalink communications makes it wasteful to allocate dedicated time slots that will guarantee no data collisions/interference at any given receiver.

There are several known methods or techniques that have been developed in an attempt to deal with the data collision/interference problem. One communications technique, frequency division multiple access (FDMA), assigns different frequencies to different users to separate their transmissions and avoid data conflicts or collisions. The problem with FDMA systems is that they require multiple frequency bandwidths, and thus system capacity is limited by the assigned frequency bandwidths.

Another communications technique that has been used for aircraft is time division multiple access (TDMA), where transmissions by a plurality of users are separated over time in an attempt to avoid data collisions. One advantage of systems using TDMA over FDMA is that TDMA systems only require a single frequency bandwidth. Time division based systems divide the available time into the smallest desired reporting period (“update rate”), also referred to as a time epoch or frame, and further subdivide each time frame into time slots. The length of a time slot is based on two primary factors: (1) the length of the message itself, and (2) the maximum propagation time for the transmitted message to be received within a predetermined area. As the size of the reception area increases, the length of the time slot must also increase, which causes TDMA systems to become less efficient because fewer time slots will fit within the desired time frame. Moreover, as the number of aircraft within the predetermined area increases, the number of data collisions also increases.

FIG. 1 illustrates how data collisions occur in TDMA based systems. As shown in FIG. 1, aircraft A transmits data during the first time slot of the time frame and aircraft B transmits data during the second time slot of the time frame. Even though the data was transmitted from aircrafts A and B at different times, the difference in the distance between aircrafts A and C and the distance between aircrafts B and C results in the transmitted signals arriving at aircraft C with part of the transmitted data from aircraft A overlapping part of the transmitted data from aircraft B. Consequently, the data transmitted from aircraft A and aircraft B is received by aircraft C as garbled data because of a data collision.

One possible solution to address this problem would be to increase the length of each time slot within the time frame to account for garbled reception within the predetermined coverage area. This solution is not viable, however, because it results in update rates that are unacceptably low, thereby potentially allowing unsafe conditions to occur.

The current Universal Access Transceiver (UAT) media access uses a hybrid TDMA media access and a random access approach in which each UAT-equipped aircraft transmits its ADS-B data in a random slot within each time frame. The theory here is that synchronous interference, where two aircraft never see each other due to repetitive interference, is prevented, because each aircraft chooses a transmission time slot randomly within each time frame and thus, the time slot selection is independent from frame to frame.

It is an accepted fact that the current UAT approach still encounters data collisions, but attempts to reduce the effects of those collisions by having each aircraft transmit its ADS-B data frequently (i.e., once per second). In high-density traffic areas, the data collision/interference problem is more pronounced.

The current UAT approach has been shown by simulation to meet ADS-B requirements in future dense environments, in some cases with very little performance margin. If the datalink is ever to be used for additional data handling, the capacity will not be sufficient. The current UAT datalink protocol has one frequency for data transmission. Again, each participant chooses a random transmit time for the ADS-B transmissions, which occur approximately once per second. In the UAT scheme, occasional data interference is tolerated as long as the average time between successful data transfers is within the requirements. FIG. 2 shows the update rate requirements (in seconds) for aircraft using a hypothetical datalink based on the distance between the transmitter (e.g., Aircraft A) and the receiver (e.g., Aircraft C). The update requirements change in “stair step” increments at distances of 20 miles, 40 miles and 60 miles for different target densities. The plotted curve in FIG. 2 shows the datalink's statistical compliance with the specified requirements. As shown in FIG. 2, the frequency of data collisions causes the update rate to be slower than the requirement in several areas (e.g., in the 40-50 nmi range). This problem will get worse as more aircraft begin using this datalink. That is, more aircraft using the- datalink means more data interference, which increases the time between successful transmissions thereby slowing the system update rate. As such, the plot in FIG. 2 will continue to move up as more aircraft adopt the equipment.

Another problem with the current UAT approach is that, even in high-density traffic areas where the number of data collisions approaches an unacceptable level, the timeline in a given region may only be about 40% full. This underutilization of the timeline prevents any additional data from being added to the existing ADS-B message.

The current UAT scheme uses completely random time slot selection, which has no control over when and where data collisions will occur. What is needed is a method for managing data transmissions between a plurality of aircraft that effectively controls the data collisions/interference, and uses the assigned frequency bandwidth more effectively.

### SUMMARY OF THE INVENTION

It is an object of the present invention to provide a method and system for managing data transmissions between a plurality of targets, such as aircraft, which provides a means by which data interference can be controlled, which in turn allows for more efficient use of the frequency bandwidth assigned to a particular communications datalink, such as the UAT datalink.

One embodiment of the present invention is a method and system of managing data transmissions from a plurality of targets (e.g., aircraft and airport support vehicles), each of which is equipped with an on-board broadcast system. The method and system include the steps of defining a plurality of geographic regions, determining the identity of each target within each geographic region, establishing a time frame within which each target will transmit data using its on-board broadcast system, assigning each geographic region a contiguous set of time slots within the established time frame and defining a time slot sequence order by which each target within each geographic region will transmit data within each respective contiguous set of time slots. Each target located within each respective geographic region is then instructed to transmit data from its on-board broadcast system at a time within the contiguous set of time slots that has been assigned for the geographic region in which it is located, using a specific time slot sequence order and a specific index point or offset within the time slot sequence order.

By assigning each region a contiguous set of time slots within the established time frame, and then making each target within a given region transmit its data using a specific time slot sequence order that differs from the sequence orders used by the other targets within the region, at least by position within the same sequence order, the number of data collisions at a given receiver will be reduced significantly. This allows the targets to achieve the required update rates and also allows for much more efficient use of the allocated frequency bandwidth.

According to one aspect of the invention, the geographic regions are defined based on designed or historical traffic patterns of the targets.

According to another aspect of the invention, the step of determining the identity of each target is performed using data broadcast from each respective target, data from a surveillance source external to each respective target and/or data from a system on each respective target.

It is preferred that the time frame is established based on at least one predetermined data transmission protocol.

According to another aspect of the invention, each set of time slots is defined based on a maximum number of targets expected within the respective geographic region, a maximum propagation time of a data transmission from a target within each respective geographic region, and/or the message length of data transmissions from the plurality of targets.

The sets of time slots overlap within the established time frame, and the amount of overlap between the sets of time slots is selected to control transmission interference between targets within different geographic regions.

According to another aspect of the invention, more than one time slot sequence order is defined for each geographic region. It is also preferred that the time slot sequence order is pseudorandom, and more preferred that the pseudorandom time slot sequence order is orthogonal to other time slot sequence orders in the geographic region or other geographic regions.

According to another aspect of the invention, each target is instructed as to the particular set of time slots in which to transmit its data based on any three of (i) a specific start time within the time frame, (ii) a specific stop time within the time frame, (iii) the number of time slots within the particular set of time slots, (iv) the size of the time slots within the particular set of time slots.

According to another aspect of the invention, at least one of start time, stop time, number of time slots and size of the time slots is transmitted to each target from a source external to the target. In addition, the specific time slot sequence order that is used by each target is determined by the target itself using one of an on-board lookup table and a predetermined algorithm.

A second embodiment of the present invention is a method and system of managing data transmissions from a plurality of aircraft, each of which is equipped with an on-board ADS-B system that transmits ADS-B data from the aircraft within an established time frame. The method and system include the steps of defining at least a first geographic region and a second geographic region, for each geographic region, dividing the established time frame into a contiguous set of time slots, and defining a time slot sequence order by which each target within each geographic region will transmit data within said established time frame. Each aircraft located within the first geographic region is instructed to transmit its ADS-B data at a specific index point or offset within the time slot sequence order for the first geographic region and each aircraft located within the second geographic region is instructed to transmit its ADS-B data at a specific index point or offset within the time slot sequence order for the second geographic region.

According to one aspect of the second embodiment, some of the aircraft located within the first geographic region are instructed to transmit their ADS-B data within the contiguous set of time slots using a specific time slot sequence order that differs from the time slot sequence order used by other aircraft within the first geographic region, and (ii) some of the aircraft located within the second geographic region are instructed to transmit their ADS-B data within the contiguous set of time slots using a specific time slot sequence order that differs from the time slot sequence order used by other aircraft within the second geographic region.

According to another aspect of the second embodiment, the contiguous set of time slots for the first geographic region partially or completely overlaps the contiguous set of time slots for the second geographic region within the established time frame. While this may result in some data collisions between aircraft within the first and second regions, there will be no data collisions between aircraft using different specific index points or offsets within the same time slot sequence order.

According to another aspect of the second embodiment, the contiguous sets of time slots for the first and second geographic regions are based on any three of (a) a specific start time within the established time frame, (b) the number of time slots within the respective set of time slots, (c) the size of the time slots within the respective set of time slots, and (d) a specific stop time within the time frame.

Preferably, each set of time slots is defined based on a maximum propagation time of a data transmission from a target within each respective geographic region.

According to another aspect of the second embodiment, more than two time slot sequence orders are defined for each geographic region. It is also preferred that the time slot sequence order is pseudorandom, and more preferred that the pseudorandom time slot sequence order is orthogonal to other time slot sequence orders in the geographic region or other geographic regions.

### BRIEF DESCRIPTION OF THE DRAWINGS

For a fuller understanding of the nature and objects of the invention, reference should be made to the following detailed description of preferred modes of practicing the invention, read in connection with the accompanying drawings, in which:

FIG. 1 is a diagram illustrating a prior art TDMA communications system;

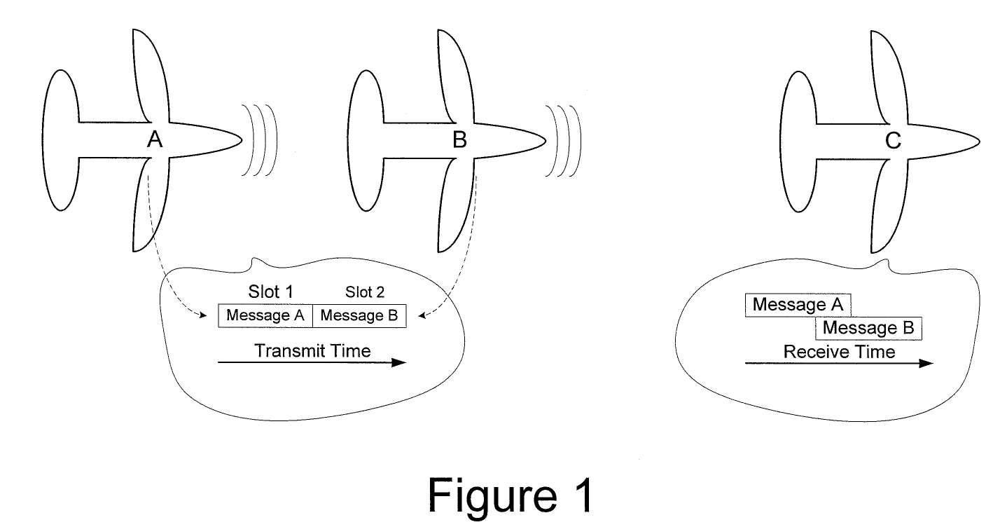

FIG. 2 is a graph comparing statistically UAT performance with required update rates for UAT-equipped aircraft;

FIG. 3 shows contiguous sets of time slots within an established time frame for geographic regions A-D in accordance with an embodiment of the present invention;

FIG. 4 shows a pseudorandom time slot sequence order used within the contiguous sets of time slots shown in FIG. 3; and

FIG. 5 is a graph showing the average update rate for UAT-equipped aircraft operating in accordance with the present invention.

### DETAILED DESCRIPTION OF THE INVENTION

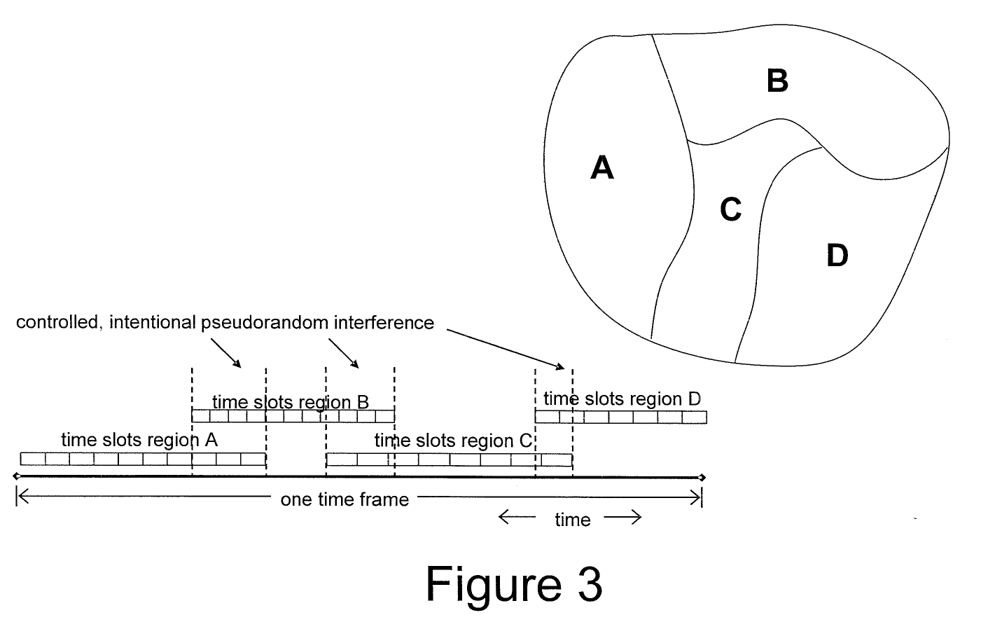

The method and system of the present invention manages data transmissions between a plurality of targets (e.g., aircraft) by using structured randomness of data transmissions to control data interference. FIG. 3 shows one example of the method and system of the present invention. One step of the invention is to divide a geographic area into a plurality of 3-dimensional geographic regions A-D. An upper or lower altitude may bound a 3-dimensional region, with other regions defining the airspace above or below the defined region. For example, in an airport setting, en route regions may overlay terminal control regions. The regions may be defined relative to a known location, such as air corridors, approach and departure corridors or TCAs, as well as historical traffic patterns and traffic densities.

Another step of the invention is to determine the identity of all the broadcast-equipped aircraft within each geographic region. The determination of aircraft identity may be based on data broadcast by the aircraft or may be derived from another source, such as a ground-based multilateration system. The determination of aircraft identity may further include determination of aircraft position based on position data transmitted by the aircraft, such as ADS-B, or positional data derived from another surveillance source, such as radar.

A time frame (see FIG. 3) is established based on the required reporting/updating rates, for example. Again, the UAT protocol has an established time frame of about one second. The time frame is subdivided to allocate a contiguous set of time slots for each defined geographic region A-D. While the size of the sets of time slots may be the same, it is more likely that the set of time slots for geographic region A, for example, will be greater than the set of time slots for geographic region B if there is more traffic expected in geographic region A. It is also possible that the length of each time slot in the set assigned to region A may differ from the length of each time slot in the set assigned to region B. It is preferred that the time slots within any one set are the same size. The length of a time slot is based on the length of the message itself and the maximum propagation time within a given geographic region.

The length of the time slots within each set shown in FIG. 3 is considerably less than the time slots associated with standard TDMA techniques, because the maximum propagation time (or maximum distance) across each defined (smaller) geographic region (A-D) is less than the maximum propagation time (or maximum distance) across the previously boundless area. Since the length of each time slot is less, more time slots are available across the time frame for data transmission, thus reducing and controlling data interference within each of regions A-D.

FIG. 3 shows that the set of time slots for region A may partially overlap with the set of time slots for region B, for example, especially in dense traffic areas. The overlapping of sets is necessary when there are insufficient time resources to assign each aircraft a slot with no data collisions/interference. By overlapping the sets of time slots as shown in FIG. 3, a controlled amount of data collisions/interference is created. The amount of overlap of time slot sets for different regions provides the capability to control the amount of data collision/interference between different proximate geographic regions. In this manner, the present invention controls the amount of data collision/interference in accordance with the data communications requirements that may be established by a governmental agency, for example.

The established time frame has been divided into four sets of time slots, as shown in FIG. 3. The aircraft within geographic region A will transmit its data (e.g., ADS-B data) within the first set of time slots, the aircraft within geographic region B will transmit its data within the second set of time slots, and so on. In order to minimize data interference between aircraft within each geographic region, the present invention assigns at least one time slot sequence order for each aircraft within geographic region A to follow from frame to frame when transmitting its data. While all the aircraft within geographic region A can use the same time slot sequence order, it would be necessary for each aircraft to start at a different position within the order, as explained in more detail below. It is also possible that aircraft within the other geographic regions could use the same time slot sequence order that is used in geographic region A, since those aircraft will be reporting within different time slot sets. It is also possible that aircraft within different regions would use different time slot sequence orders, as a means by which data interference could be controlled.

In one embodiment of the present invention the time slot sequence order is pseudorandom. More specifically, the present invention uses a feedback shift register as a time slot sequence order generator and the pseudorandom time slot sequence orders are orthogonal with respect to each other to minimize data collision/interference. In a preferred embodiment, the feedback shift register creates Gold codes for the time slot sequence orders.

The time slot sequence order assignments contain at least one of the following parameters: (1) start time, (2) stop time, (3) slot length, (4) number of slots, (5) time slot sequence order and (6) index point (or offset). In one embodiment at least one of the listed parameters is transmitted as part of the ground uplink (i.e., in the first 200 msecs of the current UAT message format). For example, if the ground provides the index point or offset within the sequence for each aircraft to transmit its data, the aircraft may be able to derive the other necessary parameters (e.g., time slot sequence order) using an on-board algorithm or database lookup table. That is, the other parameters listed above could be pre-assigned to each geographic region, for example, and that information could be derived on board the aircraft using an algorithm or database lookup table. In that manner, an aircraft within region A would only need the index point or offset from the ground authority, and would then know, based on information resident in its own equipment, the other parameters to use to transmit its data. It is possible, of course, that all of the parameters can be transmitted as part of the ground uplink. This, however, may unnecessarily clutter the available bandwidth.

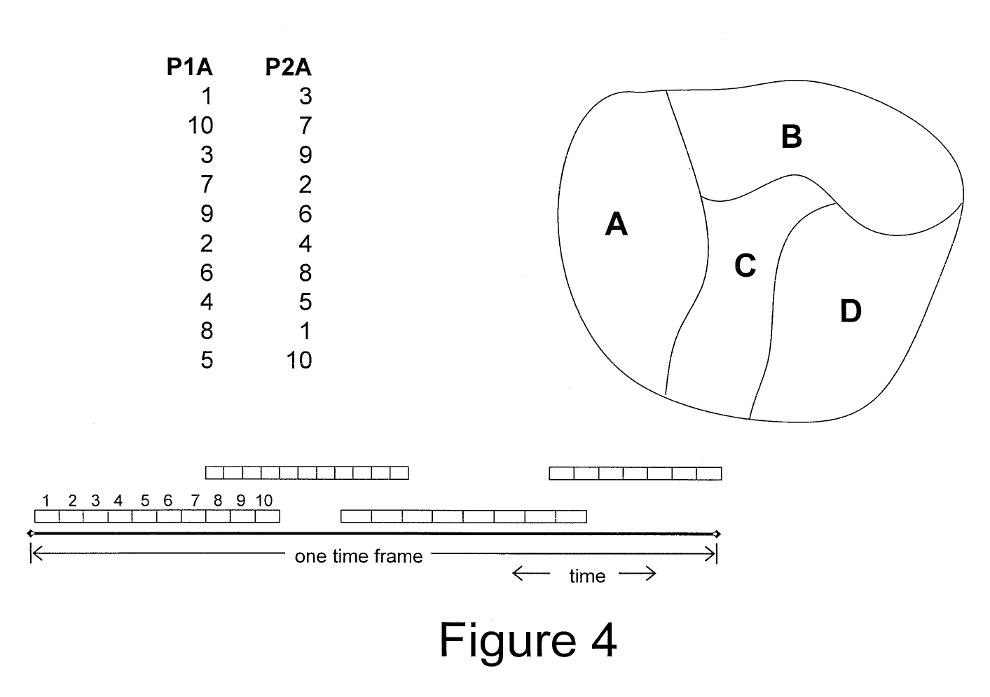

If all of the aircraft within a geographic region are using the same time slot sequence order, then each of the aircraft must be assigned a different initial slot or transmission starting point within the time slot sequence order (also referred to as an index point or offset). Again, the time slot start time and the position within the sequence order can be supplied to the aircraft, preferably by a ground authority/ground station. In one embodiment of the present invention, the ground authority/ground station uses a pseudorandom sequence for assignment of time slot sequence order. One example of a pseudorandom slot sequence is shown in FIG. 4. As shown, each of aircraft P1A and P2A uses the same pseudorandom sequence order but are assigned different index points, (i.e., slot 1 for aircraft P1A and slot 3 for aircraft P2A), such that no two aircraft in a geographic region A use the same slot at the same time. This reduces and controls the data collision/interference issues within an applicable region. In another embodiment, the slot assignments are transmitted during the ADS-B message segment as administrative messages. In yet another embodiment of the present invention, the time slot sequence order is derived by an algorithm resident on the aircraft with data parameters provided as part of the ground uplink.

The present invention assigns aircraft an initial starting point in the pseudo-random sequence of transmission times. These assigned positions in the various time slot sequence orders can be assigned in a manner that improves message update rates in critical areas, such as proximate to a busy airport.

If the number of aircraft within a given geographic region exceeds the number of time slots within the set of time slots that has been assigned to that geographic region, more than one time slot sequence order can be assigned to that geographic region. For example, half of the aircraft within the geographic region could be assigned one time slot sequence order and the other half of the aircraft within the same region could be assigned a different time slot sequence order. Each aircraft would still be assigned different, initial slots within the respective sequence orders.

It is also possible that each continuous set of time slots for each respective region encompasses the entire established time frame. For example, region A could be assigned time slots that take up the entire established time flame, and region B could also be assigned time slots (which could be the same or different from the time slots for region A) that take up the entire established time flame. The aircraft in region A would transmit data according to a time slot sequence order, but each aircraft would assume a different, initial time slot. The same scenario would apply to the aircraft in region B. Again, while some of the data transmissions from aircraft in region A may collide with data transmissions from aircraft in region B, this approach prevents any data collisions between aircraft within each respective region. As such, there is a significant net gain over the conventional UAT approach.

The pseudo randomness of the present invention makes it backward compatible with current UAT operations and allows some aircraft to operate without a time slot sequence order assignment. In fact, after a predetermined delay in which an aircraft has received no ground uplink messages containing slot assignments from a ground station/ground authority, the aircraft reverts to a default mode of operation. In one embodiment of the present invention, the aircraft reverts to a random selection of time slot for transmission.

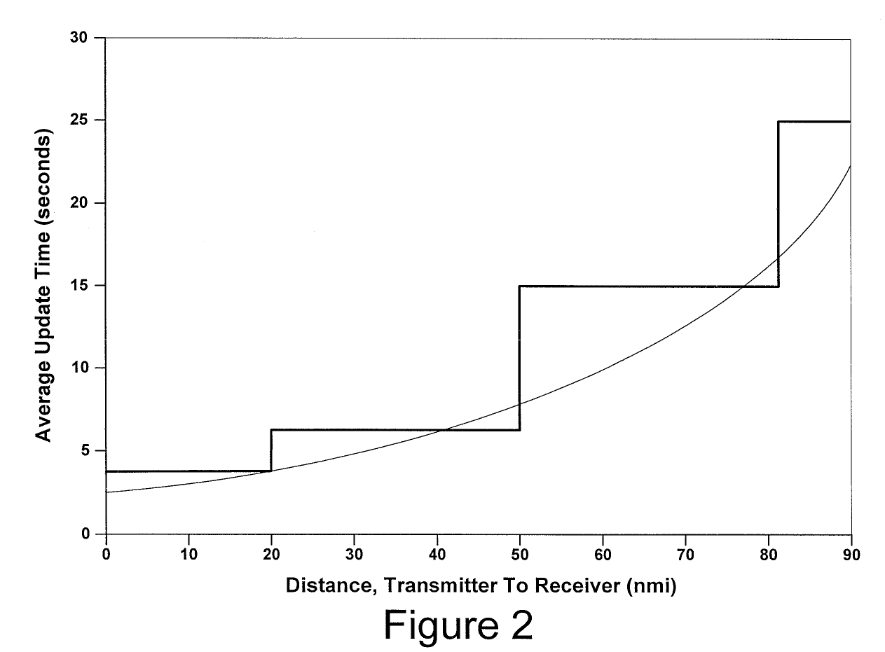

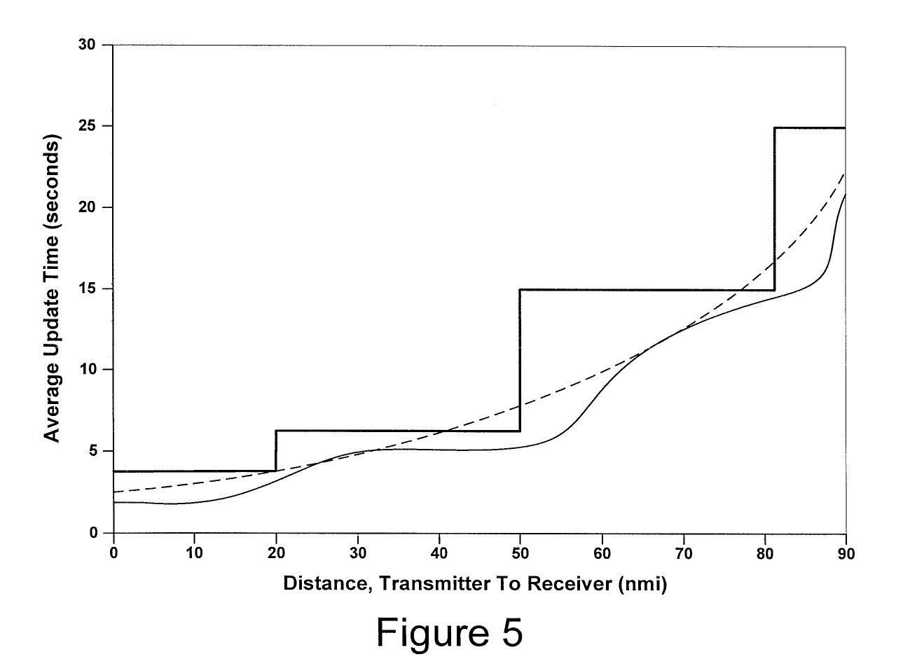

By using the methods and system of the present invention, the performance of a datalink can be improved. The person deploying the datalink and making the assignments referred to herein, for example the geographic regions, the time slots for each region, the amount of overlap between the sets of time slots, and the sequence order for the transmission of data within these sets of time slots, has wide flexibility to adjust the performance of the datalink to fit the requirements. The datalink described previously with reference to FIG. 2 has a performance represented by the curve in that figure. In that case, the access protocol used a random selection from all time slots for each transmission. For a given traffic distribution, there is no design flexibility to make the performance any different from the one shown in FIG. 2. In FIG. 5, the dashed curve shows the performance of the datalink in FIG. 2 for reference. The solid curve in FIG. 5 shows the performance of a datalink modified by the present invention. Specifically, in the case of FIG. 5, regions A-D are about 20 miles in dimension, and thus the sets of time slots are defined so as to avoid any data collisions within the respective regions. As a result, the performance can be improved in the range of 0 to 20 miles. More generally, the performance can be adjusted to clearly satisfy the “stair-step” requirements with respect to update rate. The solid curve in FIG. 5 shows conceptually the result of having many design parameters available to alter the performance of the datalink (the performance at all ranges has been improved).

Even if the performance is, at some ranges, worse than the performance of a link with random slot assignments, the performance was selectively placed where it was required by the stairstep requirement curve. Note also that the overall average performance of the datalink can be improved. In other words, performance at some ranges can be improved with limited degradation (if any) of the performance at other ranges. This is because the slot assignments within a given region are smaller, due to the smaller size of the region, and aircraft within the region are assigned different index points or offsets, assuring that aircraft within that region have no data collisions.

While the present invention has been particularly shown and described with reference to preferred embodiments, it will be understood by one skilled in the art that various changes in detail may be effected therein without departing from the spirit and scope of the invention as defined by the claims.

What is claimed is:

1. A method of managing data transmissions from a plurality of targets, each of which is equipped with an on-board broadcast system, comprising the steps of:
defining a plurality of geographic regions;
determining the identity of each target within each geographic region;
establishing a time frame within which each target will transmit data using its on-board broadcast system;
assigning each geographic region a contiguous set of time slots within the established time frame;
defining a time slot sequence order by which each target within each geographic region will transmit data within each respective contiguous set of time slots; and
instructing each target located within each respective geographic region to transmit data from its on-board broadcast system at a time within the contiguous set of time slots that has been assigned for the geographic region in which it is located, using a specific time slot sequence order and an index point or offset within said time slot sequence order.

2. The method of claim 1, wherein the geographic regions are defined based on designed or historical traffic patterns of the targets.

3. The method of claim 1, wherein the step of determining the identity of each target is performed using data broadcast from each respective target.

4. The method of claim 1, wherein the step of determining the identity of each target is performed using data from a surveillance source external to each respective target.

5. The method of claim 1, wherein the step of determining the identity of each target is performed using data from a system on each respective target.

6. The method of claim 1, wherein the time frame is established based on at least one predetermined data transmission protocol.

7. The method of claim 1, wherein each set of time slots is defined based on a maximum number of targets expected within the respective geographic region.

8. The method of claim 1, wherein each set of time slots is defined based on a maximum propagation time of a data transmission from a target within each respective geographic region.

9. The method of claim 1, wherein each set of time slots is defined based on the message length of data transmissions from the plurality of targets.

10. The method of claim 1, wherein the sets of time slots overlap within the time frame.

11. The method of claim 10, wherein the amount of overlap between the sets of time slots is selected to control transmission interference between targets within different geographic regions.

12. The method of claim 1, wherein more than one time slot sequence order is defined for each geographic region.

13. The method of claim 1, wherein the time slot sequence order is pseudorandom.

14. The method of claim 13, wherein the pseudorandom time slot sequence order is orthogonal to other time slot sequence orders in the same or any geographic region.

15. The method of claim 1, wherein each contiguous set of time slots is defined by any three of (a) a specific start time within the established time frame, (b) the number of time slots within the respective set of time slots, and (c) the size of the time slots within the respective set of time slots and (d) a specific stop time within the time frame.

16. The method of claim 15, wherein at least one of start time, stop time, number of time slots and size of the time slots is transmitted to each target from a source external to the target.

17. The method of claim 1, wherein the specific time slot sequence order that is used by each target is determined by the target itself using one of an on-board lookup table and a predetermined algorithm.

18. The method of claim 1, wherein the targets are selected from aircraft and airport support vehicles.

19. A method of managing data transmissions from a plurality of aircraft, each of which is equipped with an on-board ADS-B system that transmits ADS-B data from the aircraft within an established time frame, said method comprising the steps of:
defining at least a first geographic region and a second geographic region;
for each geographic region, dividing the established time frame into a contiguous set of time slots;
defining a time slot sequence order by which each target within each geographic region will transmit data within said established time frame; and
instructing each aircraft located within the first geographic region to transmit its ADS-B data at a specific index point or offset within said time slot sequence order for the first geographic region and each aircraft located within the second geographic region to transmit its ADS-B data at a specific index point or offset within said time slot sequence order for the second geographic region.

20. The method of claim 19, further comprising the step of (i) instructing each aircraft located within the first geographic region to transmit its ADS-B data within the contiguous set of time slots using a specific index point or offset that differs from the index point or offset used by other aircraft within the first geographic region, and (ii) instructing each aircraft located within the second geographic region to transmit its ADS-B data within the contiguous set of time slots using a specific index point or offset that differs from the index point or offset used by other aircraft within the second geographic region.

21. The method of claim 19, wherein the contiguous set of time slots for the first geographic region partially or completely overlaps the contiguous set of time slots for the second geographic region within the established time frame.

22. The method of claim 19, wherein each contiguous set of time slots is defined by any three of (a) a specific start time within the established time frame, (b) the number of time slots within the respective set of time slots, (c) the size of the time slots within the respective set of time slots, and (d) a specific stop time within the time frame.

23. The method of claim 19, wherein the geographic regions are defined based on designed or historical traffic patterns of the targets.

24. The method of claim 19, wherein each set of time slots is defined based on a maximum propagation time of a data transmission from a target within each respective geographic region.

25. The method of claim 19, wherein more than two time slot sequence orders are defined for each geographic region.

26. The method of claim 19, wherein the time slot sequence order is pseudorandom.

27. The method of claim 26, wherein the pseudorandom time slot sequence order is orthogonal to other time slot sequence orders in the same or any geographic region.

28. The method of claim 19, wherein the specific time slot sequence order that is used by each target is determined by the target itself using one of an on-board lookup table and a predetermined algorithm.
